(19) United States
(12) Patent Application Publication
(10) Pub. No.: US 2019/0217250 A1
(43) Pub. Date: Jul. 18, 2019

(54) ULTRAPURE WATER PRODUCTION APPARATUS

(71) Applicant: ORGANO CORPORATION, Tokyo (JP)

(72) Inventors: Fumitaka ICHIHARA, Tokyo (JP); Hiroshi SUGAWARA, Tokyo (JP)

(73) Assignee: ORGANO CORPORATION, Tokyo (JP)

(21) Appl. No.: 16/327,226

(22) PCT Filed: Jun. 20, 2017
(86) PCT No.: PCT/JP2017/022615

§ 371 Date: Feb. 21, 2019

(30) Foreign Application Priority Data
Aug. 24, 2016 (JP) 2016-163519

(51) Int. Cl. B01D 61/58; B01D 61/18; B01D 63/02; B01D 69/08; B01D 61/14; C02F 1/44

(52) U.S. Cl. CPC B01D 61/58; B01D 61/18; B01D 63/02; C02F 2103/04; B01D 61/142; C02F 1/444; B01D 69/08

(57) ABSTRACT

An ultrapure water production apparatus (1) includes an ultrafiltration membrane device (10). The ultrafiltration membrane device (10) includes a plurality of ultrafiltration membranes (11, 12) that are connected in series. The plurality of ultrafiltration membranes (11, 12) include a first ultrafiltration membrane (11) and a second ultrafiltration membrane (12) located farthest downstream among the plurality of ultrafiltration membranes (11, 12), the second ultrafiltration membrane (12) having filtration properties that are different from filtration properties of the first ultrafiltration membrane (11).

### TECHNICAL FIELD

The present invention relates to an ultrapure water production apparatus.

### BACKGROUND ART

In manufacturing processes of semiconductor devices and liquid crystal devices, ultrapure water, from which impurities have been removed to a high degree, is used for various purposes such as cleaning processes. Ultrapure water is typically produced by treating raw water (such as river water, groundwater, and industrial water) sequentially in a pretreatment system, primary pure water system, and secondary pure water system (subsystem).

In most subsystems, a membrane separation device, such as an ultrafiltration membrane device, is provided at the final stage to remove particles contained in ultrapure water. The particles contained in ultrapure water directly cause a reduction in device yield, and therefore their size (grain size) and number (concentration) are strictly controlled. As a result, configurations have been proposed in which a plurality of membrane separation devices are connected in series in order to decrease the number of particles in ultrapure water (see, for example, Patent Literatures 1 to 4).

### CITATION LIST

### Patent Literature

Patent Literature 1: JP 2004-283710 A

Patent Literature 2: JP 2003-190951 A

Patent Literature 3: JP 10-216721 A

Patent Literature 4: JP 04-338221 A

### SUMMARY OF THE INVENTION

### Technical Problem

The rapid development of high integration and miniaturization of semiconductor devices in recent years has brought with it increasing demand for controlling the size and number of particles. For example, according to the International Technology Roadmap for Semiconductors (ITRS), particles contained in ultrapure water must be controlled such that the number of particles having a grain size of 10 nm or more is less than or equal to 1 particle/ml. Under the current circumstances, however, the quality of treated water that can satisfy these demands cannot be obtained in the configurations disclosed in Patent Literatures 1 to 4.

It is therefore an object of the present invention to provide an ultrapure water production apparatus that produces ultrapure water in which the number of particles is sufficiently reduced.

### Solution to Problem

To achieve the above-described object, an ultrapure water production apparatus of the present includes an ultrafiltration membrane device. According to one aspect, the ultrafiltration membrane device includes a plurality of ultrafiltration membranes that are connected in series, the plurality of ultrafiltration membranes including a first ultrafiltration membrane and a second ultrafiltration membrane located farthest downstream among the plurality of ultrafiltration membranes, the second ultrafiltration membrane having filtration properties that are different from filtration properties of the first ultrafiltration membrane. According to another aspect, the ultrafiltration membrane device includes a plurality of ultrafiltration membrane modules that are connected in series, the plurality of ultrafiltration membrane modules including a first ultrafiltration membrane module and a second ultrafiltration membrane module located farthest downstream among the plurality of ultrafiltration membrane modules, the second ultrafiltration membrane module having filtration properties that are different from filtration properties of the first ultrafiltration membrane module.

### Advantageous Effects of Invention

As described above, the present invention can provide an ultrapure water production apparatus that produces ultrapure water in which the number of particles is sufficiently reduced.

### BRIEF DESCRIPTION OF THE DRAWINGS

FIG. 1 is a schematic structural view of an ultrapure water production apparatus according to an embodiment of the present invention;

FIG. 2 is an SEM photograph of particles contained in permeate water from a second UF membrane module, when UF membranes filled in two UF membrane modules of a UF membrane device shown in FIG. 1 have equivalent filtration properties; and

FIG. 3 is a schematic structural view showing a variant of the UF membrane device according to this embodiment.

### DESCRIPTION OF EMBODIMENTS

Hereinafter, an embodiment of the present invention will be described with reference to the drawings.

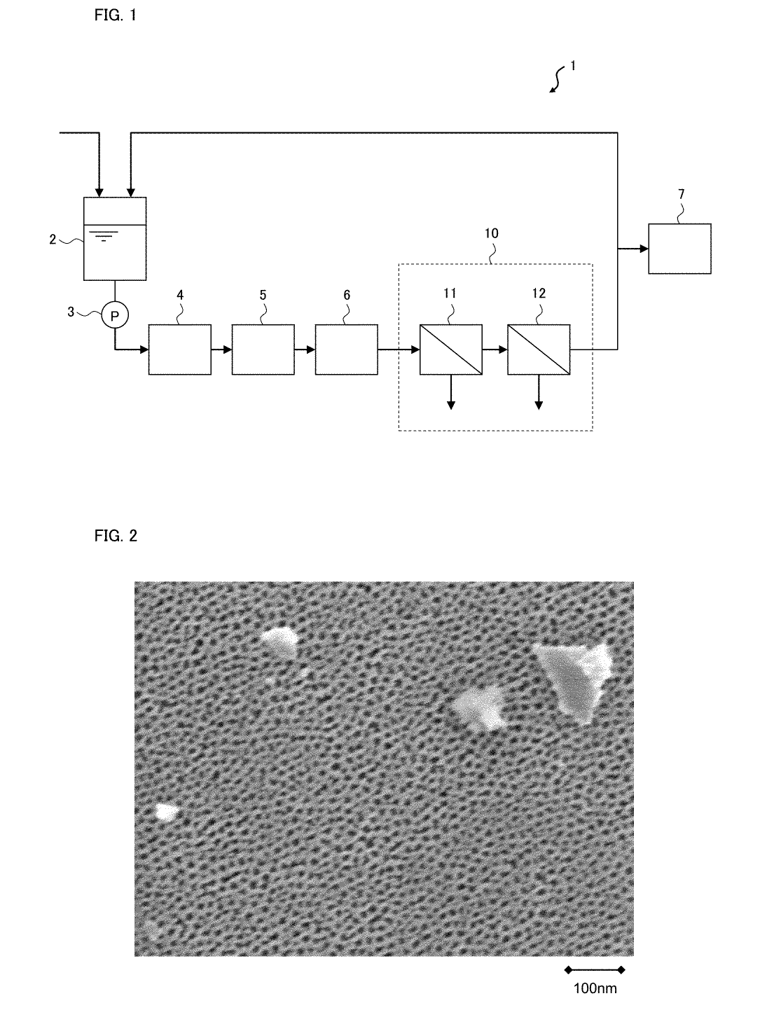

FIG. 1 is a schematic structural view of an ultrapure water production apparatus according to an embodiment of the present invention. The configuration of the ultrapure water production apparatus shown in the figure is merely an example and is not intended to limit the present invention.

Ultrapure water production apparatus 1 includes primary pure water tank 2, pump 3, heat exchanger 4, ultraviolet oxidation device 5, non-regenerative mixed-bed type ion exchange device (cartridge polisher) 6, and ultrafiltration (UF) membrane device 10. These components make up a secondary pure water system (subsystem) for sequentially treating primary pure water that is produced in a primary pure water system (not shown) to produce ultrapure water and for supplying the ultrapure water to point of use 7.

Water to be treated (primary pure water) that is stored in primary pure water tank 2 is delivered by pump 3 and supplied to heat exchanger 4. The water to be treated passes through heat exchanger 4 to be temperature-controlled and is then supplied to ultraviolet oxidation device 5 where the total organic carbon (TOC) in the water to be treated is decomposed by the irradiation of ultraviolet rays. The metals in the water to be treated are next removed by an ion exchange process in cartridge polisher 6, following which particles in the water to be treated are removed in UF membrane device 10. A portion of the ultrapure water thus obtained is supplied to point of use 7 and the remainder is returned to primary pure water tank 2. Primary pure water is supplied as necessary from the primary pure water system (not shown) to primary pure water tank 2.

As primary pure water tank 2, pump 3, heat exchanger 4, ultraviolet oxidation device 5, and cartridge polisher 6, components that are typically used in a subsystem of an ultrapure water production apparatus can be employed. Therefore, explanation of the details of these components is here omitted, and only details of UF membrane device 10 will next be described.

UF membrane device 10 includes two UF membrane modules 11, 12 connected in series. Each of UF membrane modules 11, 12 is an external-pressure type hollow fiber membrane module in which a UF membrane in the form of a plurality of bundled hollow fibers (hereinafter referred to as simply “hollow fiber membrane”) is filled in a cylindrical casing, water to be treated being supplied from outside the hollow fiber membrane, and permeate water then extracted from inside. As a filtration method in each of UF membrane modules 11, 12, a cross-flow filtration is adopted in which water to be treated is supplied parallel to the surface of the hollow fiber membrane and in which the portion of the water to be treated that does not pass through the membranes is discharged as concentrated water.

Each of the UF membranes filled in first UF membrane module 11 and second UF membrane module 12 has different filtration properties. For example, the UF membrane (second UF membrane) filled in second UF membrane module 12 has higher flux (permeate flow rate per unit membrane area and unit pressure) and thus more readily allows the passage of water, than the UF membrane (first UF membrane) filled in first UF membrane module 11. In addition, the UF membrane filled in second UF membrane module 12 has higher molecular weight cutoff and thus looser than the UF membrane filled in the first UF membrane module. The effects resulting from the higher flux and the higher molecular weight cutoff of the UF membrane of second UF membrane module 12 will be described below.

As first UF membrane module 11, a suitable configuration can be appropriately selected according to the size (grain size) of particles that are targeted for removal, and no particular limitations apply to the configuration. In this embodiment, a module is preferably used which is filled with the UF membrane having a molecular weight cutoff of 4000 to 6000, whereby particles having a grain size of 10 nm or more (hereinafter referred to as “target particles”) can be removed. The material of the UF membrane filled therein is not particularly limited, but preferably a material that is less likely to be eluted from the membrane itself, and polysulfone is suitable, as will be described below. Examples of first UF membrane module 11 as described above include UF membrane modules made by Asahi Kasei Corporation (Product No: OLT-6036H) and made by Nitto Denko Corporation (Product No.: NTU-3306-K6R). Each of these modules is filled with the hollow fiber membrane made of polysulfone having a molecular weight cutoff of 6000. The recovery ratio of first UF membrane module 11 is preferably as high as possible, and taking into consideration the accumulation of particles on the membrane surface, is preferably set to about 95%.

On the other hand, the configuration of second UF membrane module 12 is not particularly limited as long as it is filled with the UF membrane having higher flux or higher molecular weight cutoff than the UF membrane filled in first UF membrane module 11. The UF membrane having a molecular weight cutoff of, for example, 100000 to 400000 can be used as the UF membrane filled therein, and as with first UF membrane module 11, polysulfone is a suitable material therefor. An example of second UF membrane module 12 as described above includes a UF membrane module made by Asahi Kasei Corporation (Product No.: FGT-6016H). This module is filled with the hollow fiber membrane made of polysulfone having a molecular weight cutoff of 100000. When first UF membrane module 11 is filled with the UF membrane having a molecular weight cutoff of 4000, the UF membrane module made by Asahi Kasei Corporation or Nitto Denko Corporation as described above, that is filled with the UF membrane having a molecular weight cutoff of 6000, can be used as second UF membrane module 12.

In second UF membrane module 12, treated water (permeate water), from which particles have been sufficiently removed, is supplied for treatment from first UF membrane module 11, and therefore, compared to the case of first UF membrane module 11, the treatment load is lower and there is less concern regarding clogging due to the accumulation of particles on the membrane surface. For this reason, the recovery ratio of second UF membrane module 12 is preferably as high as possible and may be, for example, 95% or higher.

In the meantime, it is known that the pore diameter of the UF membrane is not completely uniform and varies from above to below the pore diameter that corresponds to its molecular weight cutoff, and therefore the grain size of particles that can be removed by the UF membrane also varies. For example, the rejection will not necessarily be 100% even for particles of a grain size greater than the pore diameter that corresponds to the molecular weight cutoff. Accordingly, in the case where a plurality of UF membrane modules are connected in series, even when the UF membranes filled therein have the same filtration properties, the quality of treated water (the number of particles) is expected to be superior compared to the case of a single UF membrane module.

In this embodiment, however, as described above, the UF membranes filled in two UF membrane modules 11, 12 do not have the same filtration properties, but downstream-side second UF membrane module 12 is filled with the UF membrane having filtration properties that are different from those of the first UF membrane, e.g., having greater flux or greater molecular weight cutoff. This configuration is based on a finding that, in order to obtain the desired quality of treated water, particles generated at the UF membrane module itself (module-derived particles) that is located farthest downstream among a plurality of UF membrane modules connected in series, must be taken into consideration. The experimental results directed to obtain this finding will be described below.

The inventors of the present invention produced ultrapure water using the ultrapure water production apparatus shown in FIG. 1 and measured the quality of treated water. More specifically, the number (concentration) of target particles (particles having a grain size of 10 nm or more) that are contained in treated water (permeate water) from each UF membrane module of the UF membrane device was measured.

A UF membrane module filled with the UF membrane made of polysulfone having molecular weight cutoff of 6000 was used as each of the first and second UF membrane modules, and two types of UF membrane modules made by company A and company B were prepared as this UF membrane module. The permeate flow rate of each UF membrane module was 15 m³/h.

In addition, the number of particles in the permeate water was calculated by a direct microscopic count method (SEM method) as described below. More specifically, the permeate water of each UF membrane module was supplied to a particle capture device having a filtration membrane to capture particles, a scanning electron microscope (SEM) was used to observe the number and grain size of the particles captured in the filtration membrane, and then the number (concentration) of the target particles was calculated.

Table 1 shows the measurement results regarding the number of particles in the permeate water for each of the two types of UF membrane modules.

TABLE 1

| | | UF membrame module | |
|---|---|---|---|
| | | Company | Company |
| | | A | B |
| Number of particles | First UF membrane module | 20 | 20 |
| in permeate water | Second UF membrane | 10 | 10 |
| [particles/ml] | module | | |

As can be clearly seen in Table 1, it was confirmed that, for both of the UF modules made by companies A and B, there were no major differences between the number of target particles in the permeate water from the second UF membrane module and that in the permeate water from the first UF membrane module. This result demonstrates that the quality of treated water as good as would be expected from the above-described principles was not obtained.

In this regard, FIG. 2 shows an example of an SEM photograph of particles contained in permeate water from the second UF membrane module.

From FIG. 2, it was confirmed that the permeate water from the second UF membrane module contains particles having a grain size of 100 nm or more, which is considerably greater than the size corresponding to the molecular weight cutoff of the UF membrane of each UF membrane module. Considering that almost all of the target particles (for example, 100 to 1000 particles/ml) contained in water to be treated are removed by the first UF membrane module, it is highly unlikely that particles having a grain size of 100 nm or more in the permeate water from the second UF membrane module are those originally contained in the water to be treated, and therefore these particles are highly likely to be generated at the UF membrane module itself. In actuality, from the composition analysis performed using an energy-dispersive X-ray analyzer (EDX) for a portion of the particles contained in the permeate water from the first UF membrane module, it is confirmed that most of the particles having a grain size of 100 nm or more are organic compounds containing carbon and sulfur that are the constituent elements of the UF membrane (polysulfone). Note that particles that are considered to have generated at the first UF membrane module are believed to be removed in the second UF membrane module.

On the basis of the foregoing, in order to obtain the desired quality of treated water, specifically, to produce treated water (ultrapure water) in which the number of particles having a grain size of 10 nm or more is less than 10 particles/ml, preferably 5 particles/ml, and still more preferably 1 particle/ml when evaluated by direct microscopic count as described above, the number of module-derived particles of the particles contained in the treated water, must be decreased. To this end, the number of particles generated at the UF membrane module that is located farthest downstream among the plurality of UF membrane modules that are connected in series, must be decreased. The particle removal capability of the farthest downstream UF membrane module is sufficient as long as it can remove large particles of 100 nm or more that are generated at the UF membrane modules other than the farthest downstream UF membrane module.

From this standpoint, in this embodiment, downstream-side second UF membrane module 12 is filled with the UF membrane that has greater flux, and in particular, that has greater molecular weight cutoff than the UF membrane filled in upstream-side first UF membrane module 11, as described above. Second UF membrane module 12 allows the passage of water at a flow rate greater than in first UF membrane module 11, and therefore can easily discharge particles generated at second UF membrane module 12 itself to outside the system when it is cleaned. Accordingly, module-derived particles of the particles contained in the ultrapure water can be reduced.

Still further, the passage of water at a greater flow rate through second UF membrane module 12 also leads to an increase in the permeate flow rate per unit pressure. As a result, not only can the absolute number of particles be reduced due to the above-described improvement of the cleaning effect, but the relative number of particles, i.e., the particle concentration in the permeate water (ultrapure water) can also be reduced due to the dilution effect resulting from the increase of the permeate flow rate.

According to this embodiment, therefore, the number of particles in ultrapure water can be sufficiently decreased to obtain the desired quality of treated water.

On the other hand, the passage of water at a greater flow rate through second UF membrane module 12 is advantageous in that the cost savings can be expected due to shortening of the cleaning process. In other words, since the attachment of particles cannot be avoided during manufacture of the UF membrane module, at least during start-up of the device, a large amount of ultrapure water (or pure water) must be used for cleaning the module before the desired quality of treated water can be attained. In second UF membrane module 12 of this embodiment, however, the above-described improvement of the cleaning effect allows particles generated at second UF membrane module 12 to be easily discharged to outside the system so as to drastically reduce the time and costs required for this cleaning.

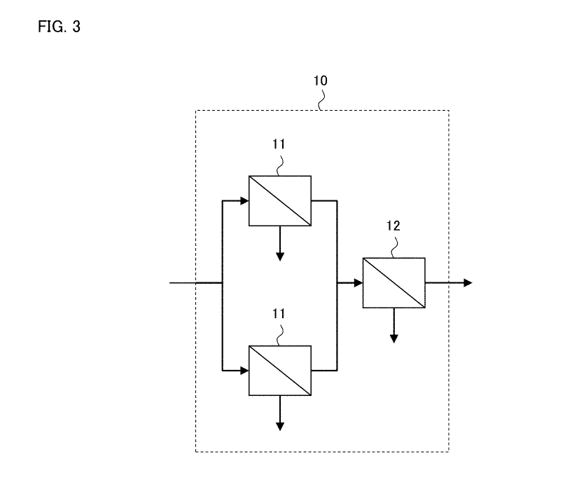

Several methods can be considered as the actual operation method (the method of supplying water to be treated to second UF membrane module 12). For example, after cleaning second UF membrane module 12 beforehand at a high flow rate to reduce the generation of module-derived particles as much as possible, steady operation may be carried out at a lower flow rate (for example, such that water flows at a flow rate comparable to that in first UF membrane module 11). Alternatively, a plurality of first UF membrane modules 11 may be connected in parallel as shown in FIG. 3, and these UF membrane modules may then be connected in series to second UF membrane module 12 to supply the permeate water from the plurality of first UF membrane modules 11 to second UF membrane module 12.

The prolonged passage of water at a high flow rate through an external-pressure type UF membrane module may cause defects such as occurrence of fiber breakage (of the hollow fiber membrane) or decrease of filtration stability due to the impact of the water flow. Accordingly, from the standpoint of preventing the occurrence of such defects, second UF membrane module 12 may be an internal-pressure type UF membrane module. In addition, there is little concern for clogging even when the recovery ratio is set high in second UF membrane module 12 as described above, and therefore, as the filtration method, a dead-end filtration may be adopted in which the total amount of water to be treated is filtered.

In the embodiment described above, by filling the UF membrane modules with the UF membranes each having different molecular weight cutoff or flux to change the permeate flow rate per unit pressure of each UF membrane module, the filtration properties of each UF membrane module are changed. However, the method of changing the filtration properties is not limited to this. For example, the permeate flow rate per unit pressure of each of the UF membrane modules may be changed by filling them with the UF membranes having the same molecular weight cutoff at different filling rates, or by using different membrane thickness or membrane material, so that the filtration properties of each UF membrane module can be changed.

Further, in the embodiment described above, two UF membrane modules that are connected in series are described by way of example. However, the present invention is not limited to this, and may be applied to three or more UF membrane modules that are connected in series. For example, if three UF membrane modules are used, one UF membrane module could be added to the two UF membrane modules shown in FIG. 1. In this case, the UF membrane module, that is identical to the second UF membrane module and that is filled with the UF membrane having filtration properties different from those of the first UF membrane, can be added between the first UF membrane module and the second UF membrane module or added upstream of the first UF membrane module. From the standpoint of more effectively removing particles contained in water to be treated, the UF membrane module that is identical to the second UF membrane module is preferably added upstream of the first UF membrane module. A hollow-fiber microfiltration membrane module may also be added downstream of the plurality of UF membrane modules.

### REFERENCE SIGNS LIST

1 Ultrapure water production apparatus
2 Primary pure water tank
3 Pump
4 Heat exchanger
5 Ultraviolet oxidation device
6 Non-regenerative mixed-bed type ion exchange device (cartridge polisher)
7 Point of use
10 UF membrane device
11 First UF membrane module
12 Second UF membrane module

1. An ultrapure water production apparatus including an ultrafiltration membrane device, wherein
the ultrafiltration membrane device includes a plurality of ultrafiltration membranes that are connected in series, and
the plurality of ultrafiltration membranes includes a first ultrafiltration membrane and a second ultrafiltration membrane having filtration properties that are different from filtration properties of the first ultrafiltration membrane, the second ultrafiltration membrane located farthest downstream among the plurality of ultrafiltration membranes.

2. The ultrapure water production apparatus according to claim 1, wherein the flux of the second ultrafiltration membrane is greater than the flux of the first ultrafiltration membrane.

3. The ultrapure water production apparatus according to claim 1, wherein the molecular weight cutoff of the second ultrafiltration membrane is greater than the molecular weight cutoff of the first ultrafiltration membrane.

4. The ultrapure water production apparatus according to claim 1, wherein each of the plurality of ultrafiltration membranes is a hollow fiber membrane.

5. An ultrapure water production apparatus including an ultrafiltration membrane device, wherein
the ultrafiltration membrane device includes a plurality of ultrafiltration membrane modules that are connected in series, and
the plurality of ultrafiltration membrane modules include a first ultrafiltration membrane module and a second ultrafiltration membrane module having filtration properties that are different from filtration properties of the first ultrafiltration membrane module, the second ultrafiltration membrane module located farthest downstream among the plurality of ultrafiltration membrane modules.

6. The ultrapure water production apparatus according to claim 5, wherein the permeate flow rate per unit pressure of the second ultrafiltration membrane module is greater than the permeate flow rate per unit pressure of the first ultrafiltration membrane module.

7. The ultrapure water production apparatus according to claim 5, wherein each of the plurality of ultrafiltration membrane modules is a hollow fiber membrane module.

8. The ultrapure water production apparatus according to claim 7, wherein the second ultrafiltration membrane module is an internal-pressure type hollow fiber membrane module.

9. The ultrapure water production apparatus according to claim 7, wherein the second ultrafiltration membrane module is a dead-end filtration type hollow fiber membrane module.
